(19) United States
(12) Patent Application Publication
(10) Pub. No.: US 2026/0073724 A1
(43) Pub. Date: Mar. 12, 2026

(54) ENRICHMENT OF EXTRACTION PROMPTS FOR DOCUMENT PROCESSING SYSTEMS

(71) Applicant: SAP SE, Walldorf (DE)

(72) Inventors: Christoph Meyer, Berlin (DE); Manuel Zeise, Karlsruhe (DE)

(21) Appl. No.: 18/829,711

(22) Filed: Sep. 10, 2024

(51) Int. Cl. G06V 30/412; G06V 30/262; G06V 30/416

(52) U.S. Cl. CPC G06V 30/412; G06V 30/262; G06V 30/416

(57) ABSTRACT

The disclosure generally describes methods, software, and systems for document data extraction. A digitalized document in a layout-preserving text representation is obtained. A document type of the digitalized document can be determined based on its structural characteristics. Contextual data related to the document type of the digitalized document can be obtained. A prompt comprising a data field extraction schema corresponding to the document type of the digitalized document can be generated. The prompt can be enriched based on the contextual data and the respective layout of the data fields in the digitalized document. The enriched prompt can define ranges for one or more data fields. A structured document can be obtained from the execution of a prediction engine based on the enriched prompt invoked for the digitalized document. The structured document can be provided for semantic querying to extract portions of data from the structured document.

### TECHNICAL FIELD

The present disclosure relates to computer-implemented methods, software, and systems for data processing and document data extraction.

### BACKGROUND

Complex document

layouts can be associated with difficulties in accurate data extraction from documents, leading to data extraction errors. The document data extraction errors can occur for various reasons, depending on the type of document or the used extraction method. For example, in some cases, the extraction can yield an incorrect value for a particular field of the document or can fail to extract a value from a field. For example, some types of errors can occur due to an incorrect interpretation of a missing value. Other errors can occur due to an incorrect association of fields and values.

### SUMMARY

Implementations of the present disclosure are directed to techniques and tools for document data extraction. More particularly, implementations of the present disclosure are directed to enrichment of extraction prompts used by a machine learning model to perform document data extraction.

In some implementations, a method includes: obtaining a digitalized document including data fields in a layout-preserving text representation including structural characteristics defining a respective layout; determining a document type of the digitalized document based on the structural characteristics of the digitalized document; obtaining, from a storage, contextual data related to the document type of the digitalized document; generating a prompt including a data field extraction schema corresponding to the document type of the digitalized document; enriching the prompt based on the contextual data and the respective layout of the data fields in the digitalized document to generate an enriched prompt, wherein the enriched prompt defines ranges for one or more data fields; obtaining, from an execution of a prediction engine, a structured document based on the enriched prompt invoked for the digitalized document; and providing the structured document for semantic querying to extract portions of data from the structured document to trigger a process execution at an application based on the extracted portions of data.

The foregoing and other implementations can each optionally include one or more of the following features, alone or in combination. In particular, implementations can include all of the following features. In some instances, obtaining the digitalized document can include receiving, from an external system, an original document including a semantically unsearchable format, the external system being identified by sender information, and applying text recognition and formatting alpha-numeric values according to set formatting rules to the original document.

In some instances, the enriched prompt can include the digitalized document formatted according to the original layout of the original document. In some instances, the ranges for the data fields of the digitalized document can be determined based on the sender information.

In some instances, the contextual data can include a document identifier range that is compared to a document identifier to determine validity of the digitalized document. In some instances, values of the data fields can be processed using one or more rules defining the validity of the values according to the document type. In some instances, the storage can be populated with data during provisioning of the storage with data obtained from related computer applications or systems that can receive extracted data from the processed digitalized document. In some instances, obtaining, from the storage, the contextual data related to the document type of the digitalized document can include invoking multiple submodules related to different portions of the corresponding document type.

Other implementations of the aspect include corresponding systems, apparatus, and computer programs, configured to perform the actions of the methods, encoded on computer storage devices. The present disclosure also provides a computer-readable storage medium coupled to one or more processors and having instructions stored thereon which, when executed by the one or more processors, cause the one or more processors to perform operations in accordance with the implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with the implementations of the methods provided herein.

These and other implementations can each optionally include one or more of the following advantages. The described implementation provides an efficient automatic data extraction from digitalized documents. The system streamlines the action, system, and data extraction process by matching contexts and document types, enabling efficient and accurate data extraction without an overwhelming complexity. The described implementation provides an enhanced system productivity by automating a sequence of data extraction using enriched prompts. The system enhances productivity, saving valuable time and effort in data extraction and execution of data processing workflows with corresponding systems and applications, which minimizes usage of system resources and eliminates system incompatibility. The described enhanced implementations facilitate using a user-friendly interface for data extraction and a seamless process for invoking the data processing sequence.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the subject matter of the specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example system for data extraction, according to some implementations of the present disclosure.

FIG. 2 Is a Block diagram of an example system architecture for data extraction, according to some implementations of the present disclosure.

FIG. 3 is an example prompt generation scenario for data extraction, according to some implementations of the present disclosure.

FIG. 4 Is a flowchart of an example process for data extraction, according to some implementations of the present disclosure.

FIG. 5 is a block diagram of an exemplary computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

The present disclosure relates to document data extraction. More particularly, implementations of the present disclosure are directed to the enrichment of prompts used to query large language models (LLM) to extract data from documents. In some instances, document information extraction processes can be designed as a web-based service to extract logical entities from scanned documents (e.g., invoices, order requests, and order confirmations). The logical entities can include header information, such as document date, sender name, sender account information, sender identifier, and body information, that can include information in tables or images. The tables can include line items with fields such as line-item text, a line-item quantity, and/or a line-item amount. For example, the table data can include numeral values related to items transferred between the parties (e.g., number of items sold or shipped). In some instances, an initial document can be processed with an optical character recognition (OCR) application or service to yield the text on the document with two-dimensional spatial information (i.e., the location of the extracted text on the document).

In some implementations extracting data from a document can include performing multiple operations including processing a scanned document (e.g., uploaded by a user or through an application) with an OCR solution to yield the text part of the document with two-dimensional spatial information. For example, the location of the extracted text on the document can be represented using two-dimensional spatial information. Based on the processed OCRed document, one or multiple software components can extract some or all logical entities based on the image and/or the spatial text information that was generated during the OCR operation. The components that can be used to process the OCRed document can implement rule-based extraction heuristics, neural network-based extraction models such as encoder-only transformers (Charmer), Large Language Models (LLM), or post-processing logic (e.g., to perform sender address harmonization and matching) to extract some or all data from the document. In some instances, an orchestration layer can control the execution of the data extraction (from one or multiple components) and obtained data from the component(s) can be merged. In some instances, the result can be persisted in a data storage and provided to users to query and retrieve at least a portion of the extracted data.

In some cases, available data extraction method can yield a wrong value for a particular field or can fail to extract a field. For example, the extraction can be performed based on using a neural network, and depending on a type of neural network that is used, one or both types of the following error modes can occur (i) hallucination of values that are not included in the document and (ii) extraction of the wrong value from the document. For example, hallucination of values can occur with generative models such as LLMs, when an LLM is prompted to extract a field from a scanned document, for which there is no information on the document. Due to the missing field information, the LLM may incorrectly fill in a value according to the distribution it has seen during training for the missing value. In another example, incorrect value extraction can be due to extraction of information that is on the document but not the correct value for the field that is requested. The incorrect value extraction can also appear in cases where the field is present on the document but not extracted, yielding an empty prediction.

To address limitations of available data extraction mechanisms, the context-based protocol described in the present disclosure provides an automatic and accurate data extraction from digitalized documents. The described solution overcomes potential challenges in data extraction, while also ensuring efficient and accurate (and contextually relevant) invocations by using suitable connectors to external systems and compatible adapters for the external systems. The contextually relevant system invocations can be performed by relying on the definition of allowed (or acceptable) values for fields. For example, based on techniques of the present disclosure, when data is requested to be invoked, the invocation can consider definitions of particular ranges or sets of values defined by context information as relevant for the invoked data. As such, the data extraction is enhanced to seamlessly identify and integrate data (e.g., data ranges, data types, data formatting, or other data characteristics) from internal and external systems.

In accordance with the implementations of the present disclosure, an enriched prompt can be generated and used to query a prediction engine that is trained in generating and executing optimized data extraction scenarios for generating structured documents from received scanned documents. In some implementations, prediction engines can be prompted with enriched prompts that provide contextual information to support precise data invocation in an optimized and adaptable manner, which can be flexibly used when handling diverse document types that are queried to extract data. Further, the described approach addresses the balance between natural language text validation and purposeful data extraction execution using prediction engines (e.g., LLM models) for optimized identification of data layouts and executable data extraction scenarios according to the context derived limits imposed based on the data types. According to the described approach, document information extraction is performed with minimized processing costs and data storage costs to provide accurate results.

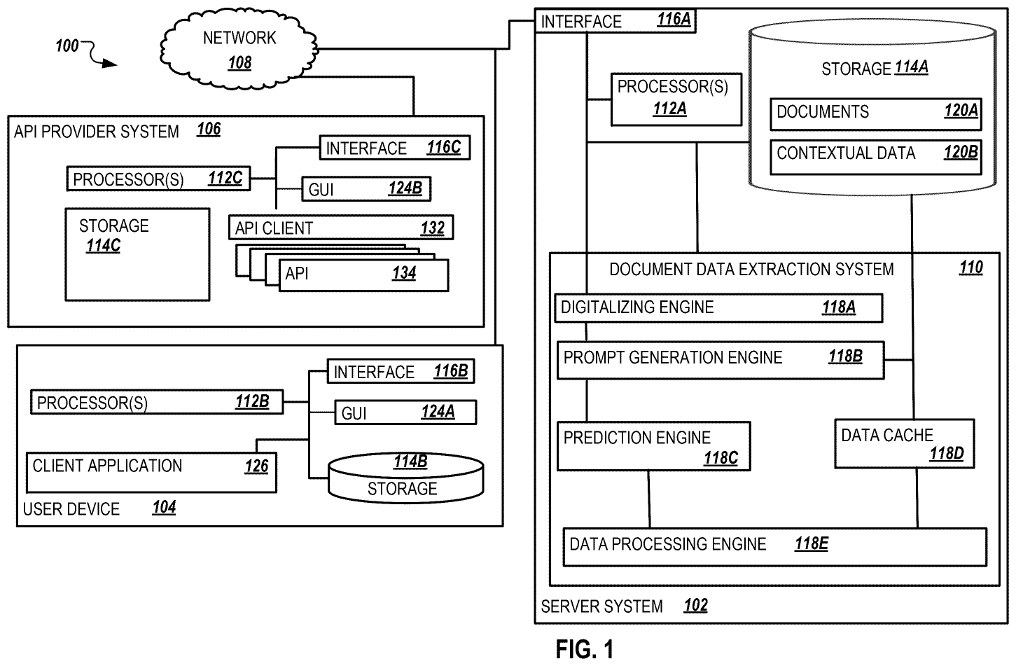

FIG. 1 is a block diagram of an example system 100 for data extraction based on layout identification, according to some implementations of the present disclosure. Specifically, the illustrated example system 100 includes, or is communicably coupled with a server system 102, a user device 104, an API provider system 106, and a network 108. Although shown separately, in some implementations, the functionality of two or more systems or servers can be provided by a single system or server. In some implementations, the functionality of one illustrated system, server, or component can be provided by multiple systems, servers, or components, respectively.

In the example of FIG. 1, the server system 102 is intended to represent various forms of servers including, but not limited to a web server, an application server, a proxy server, a network server, and/or a server pool. In general, the server systems 102 accept requests for application services and provides such services to any number of user devices 104 (e.g., the client device 104 over the network 108). In accordance with the implementations of the present disclosure, and as noted above, the server system 102 can host a solution environment that can be a cloud environment providing software applications, systems, and services that can be consumed by customers as a service.

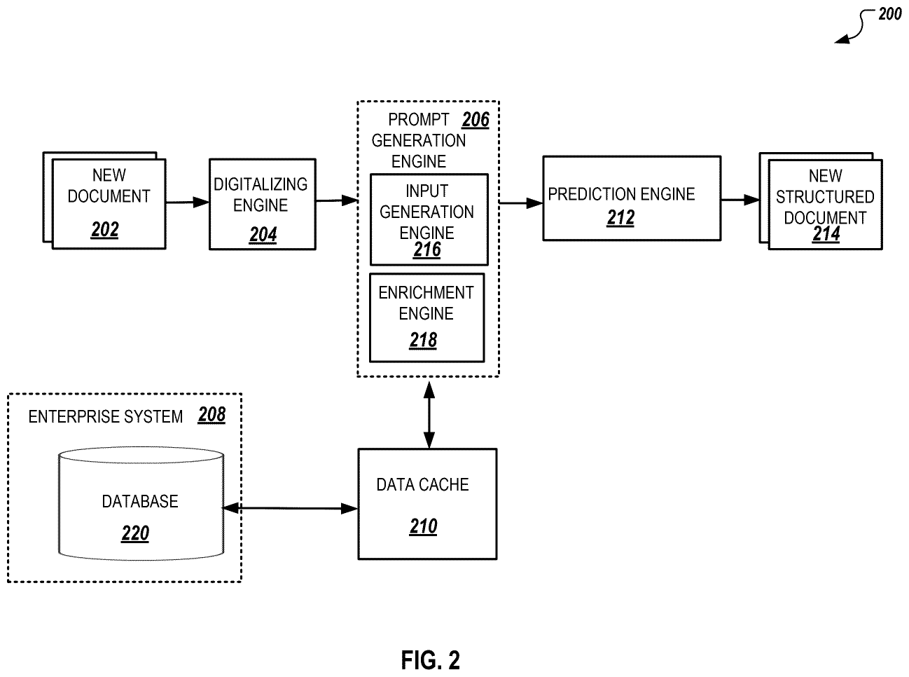

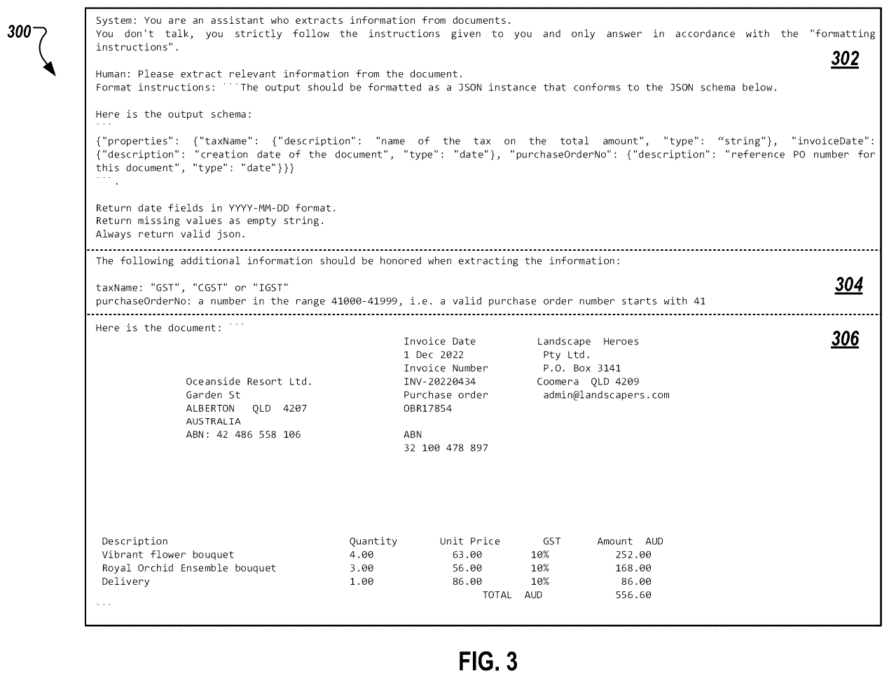

In some implementations, the server system 102 can support the configuring of various tenants of different types, as well as services of different types that are integrated into customer integration scenarios and support the execution of the defined processes. For example, the server system 102 includes a document data extraction system 110, a processor 112A, a storage 114A, and an interface 116A. The document data extraction system 110 can include a digitalizing engine 118A, a prompt generation engine 118B, a prediction engine 118C, a data cache 118D, and a data processing engine 118E. As user devices 104 generate requests for searching data in one or more documents, the document data extraction system 110 can be used to digitalize, identify contextual data 120B, and extract data from the documents 120A, as described with reference to FIGS. 2, 3. The prediction engine 118C can identify, based on contextual data 120B, a corresponding layout for data extraction to generate a structured document according to the corresponding identified layout The data processing engine 118E can execute searching for data extracted from the processed documents at the document data extraction system and store the structured document.

The storage 114A of the server system 102 can include documents 120A and contextual data 120B. The documents 120A can include template documents corresponding to particular layouts, that are used for training the prediction engine 118C, documents to be processed by the document data extraction system 110, or documents provided after processing by the document data extraction system 110 (e.g., structured documents). For example, the documents 120A can include documents having layouts that can be specifically associated as provided from a particular user device 104 or API provider system(s) 106. In some instances, documents 120A can provide references to external resources, which can define particular document structures and can be used to obtain contextual data for the documents to be stored at the contextual data 120B.

In some instances, the contextual data 120B can include a table of data ranges for particular fields or sequences of alphanumeric values and images corresponding to a system associated with data stored in the documents. For example, the table of data ranges and images can correspond to a sending and receiving system(s) used for generating, processing, providing, or acquiring of the documents. The contextual data 120B can be structured as a collection of range data stored as an entity. The document data extraction system 110 can condition the prediction engine 118C, based on the contextual data 120B, to generate structured documents when extracting data from received documents.

The user device 104 and the API provider system 106 can each be any computing device operable to connect to or communicate in the network(s) 108 using a wireline or wireless connection. In general, each of the user device 104 and the API provider system 106 includes an electronic computer device operable to receive, transmit, process, and store any appropriate data associated with the system 100 of FIG. 1. Each of the user device 104 and the API provider system 106 is generally intended to encompass any client computing device such as a laptop/notebook computer, wireless data port, smart phone, personal data assistant (PDA), tablet computing device, one or more processors within these devices, or any other suitable processing device. The client device 104 and the API provider system 106 respectively include an interface(s) 116B and 116C, processor(s) 112B and 112C, storages 114B and 114C, and graphical user interface(s) (GUIs) 124A and 124B. The user device 104 can include one or more client applications 126. The client application 126 can be any type of application that allows a client device to request, obtain, or display content on the client device (e.g., generate a request for synchronized customer data). In some implementations, a client application 126 can use parameters, metadata, and other API and event dependency information received at launch to access the document data extraction system 110 from the server system 102. In some instances, a client application 126 can be an agent or client-side version of the one or more enterprise applications running on an enterprise server (not shown). The API provider system 106 can include an API client 132 and APIs 134 that can be used for invoking API sequences.

In some implementations, any or all of the components of the example system 100, both hardware or software (or a combination of hardware and software), can interface with each other or the interface(s) 116A, 116B, and 116C (or a combination of both) over the network 108 for using a sequence of APIs 134. The APIs 134 can include specifications for routines, data structures, and object classes. The APIs 134 can be either computer-language independent or dependent and refer to a complete interface, a single function, or even a set of APIs 134 that are called, by the document data extraction system 110, for providing software services to the user device 104 or other components (whether or not illustrated) that are communicably coupled to the user device 104. The functionality of the user device 104 can be accessible for all service consumers using the client application 126, which transmits prompts to the document data extraction system 110 to process one or more documents 120A for data extraction. In some instances, the one or more documents 120A can be documents that are provided by the user device 104 and are requested to be processed so that data is extracted from the documents and is stored at a predefined enterprise system. In some instances, the one or more documents 120A can be processed at the document data extraction system 110 where an enriched prompt can be generated and used to perform the data extraction. The enhanced prompt can be generated based on contextual data associated with the predefined enterprise system at which the data is to be stored. In some instances, the contextual data can be obtained from the predefined enterprise system or can be retrieved from the contextual data 120B of the server system 102 (when the server system 102 is provided with contextual data for that particular enterprise system).

For example, the user device 104 and/or the API provider system 106 can include a computer that includes an input device, such as a keypad, touch screen, or other device that can accept user information, and an output device that conveys information associated with the operation of the server system 102, or the client device itself, including digital data, visual information, or a GUI 124A, and 124B, respectively. The GUI 124A, and 124B each interface with at least a portion of the system 100 for any suitable purpose, including generating a visual representation of the client application 126 or the visual representation associated with the processes executed at the processors 112C, respectively. In particular, the GUIs 124A, and 124B can each be used to view and navigate various Web pages. The GUIs 124A, and 124B each provide the user with an efficient and user-friendly presentation of business data provided by or communicated within the system. The GUIs 124A, and 124B can each include multiple customizable frames or views having interactive fields, pull-down lists, and buttons operated by the user. The GUIs 124A, and 124B each contemplate any suitable graphical user interface, such as a combination of a generic web browser, intelligent engine, and command line interface (CLI) that processes information and efficiently presents the results to the user visually.

In some implementations, the network 108 can include a large computer network, such as a local area network (LAN), a wide area network (WAN), the Internet, a cellular network, a telephone network (e.g., PSTN), or an appropriate combination thereof connecting any number of communication devices, mobile computing devices, fixed computing devices and server systems. Data exchanged over the network 108, is transferred using any number of network layer protocols, such as Internet Protocol (IP), Multiprotocol Label Switching (MPLS), Asynchronous Transfer Mode (ATM), Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 112A, 112B, and 112C included in the user device 104 or the API provider system 106 can be a central processing unit (CPU), a graphics processing unit (GPU), a tensor processing unit (TPU), an application specific integrated circuit (ASIC), a field-programmable gate array (FPGA), or another suitable component. Each processor 112A, 112B, and 112C included in the user device 104 or the API provider system 106 executes instructions and manipulates data to perform the operations of the user device 104 or the API provider system 106, respectively. Specifically, each processor 112A, 112B, and 112C included in the user device 104 or the API provider system 106 executes the functionality required to send requests to the server system 102 and to receive and process responses from the server system 102. Each processor 112A, 112B, and 112C can be a CPU, a blade, an ASIC, a FPGA, or another suitable component. Each processor 112A, 112B, and 112C executes instructions and manipulates data to perform the operations of the respective system (the server system 102, the user device 104, and the API provider system 106). Specifically, each processor 112A, 112B, and 112C executes the functionality required to receive and respond to requests from the respective system (the server system 102, the user device 104, and the API provider system 106), for example.

The storages 114a, 114B, and 114C can include any type of memory or database module and can take the form of volatile and/or non-volatile memory including, without limitation, magnetic media, optical media, random access memory (RAM), read-only memory (ROM), removable media, or any other suitable local or remote memory component. The storage 114A, 114B, and 114C can store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the server system 102, the user device 104, or the API provider system 106, respectively. In some implementations, the storage 114A can be connected to the cache 118D (as shown in FIG. 1) or can include the cache 118D.

Interfaces 116a, 116b, and 116C are used by the server system 102, the user device 104, and the API provider system 106, respectively, for communicating with other systems in a distributed environment - including within the system 100 - connected to the network 108. Generally, the interfaces 116A, 116B, and 116C each include logic encoded in software and/or hardware in a suitable combination and operable to communicate with the network 108. More specifically, interfaces 116A, 116B, and 116C can each include software supporting one or more communication protocols associated with communications such that the network 108 or interface's hardware is operable to communicate physical signals within and outside of the illustrated system 100.

There can be any number of user devices 104 and API provider systems 106 associated with, or external to, the system 100. Additionally, there can also be one or more additional client devices external to the illustrated portion of system 100 that are capable of interacting with the system 100 via the network(s) 108. Further, the terms “client,” “client device,” and “user” can be used interchangeably as appropriate without departing from the scope of the disclosure. Moreover, while the client device can be described in terms of being used by a single user, the disclosure contemplates that many users can use one computer, or that one user can use multiple computers. As used in the present disclosure, the term “computer” is intended to encompass any suitable processing device. For example, although FIG. 1 illustrates a single server system 102, a single user device 104, and a single API provider system 106, the system 100 can be implemented using a single, stand-alone computing device, two or more servers 102, or multiple client devices. The server system 102, the user device 104, and the API provider system 106 can include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server system 102, the user device 104, and the API provider system 106 can be adapted to execute any operating system or runtime environment, including Linux, UNIX, Windows, Mac OS®, Java™, Android™, iOS, BSD (Berkeley Software Distribution) or any other suitable operating system. According to one implementation, the server system 102 can also include or be communicably coupled with an e-mail server, a Web server, a caching server, a streaming data server, and/or another suitable server.

Regardless of a particular implementation, “software” can include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language including C, C++, Java™, JavaScript®, Python, Visual Basic, assembler, Perl®, ABAP (Advanced Business Application Programming), ABAP OO (Object Oriented), any suitable version of 5GL, as well as others. While portions of the software illustrated in FIG. 1 are shown as individual modules that implement the various features and functionality through various objects, methods, or other processes, the software can instead include multiple sub-modules, third-party services, components, libraries, and such, as appropriate. Conversely, the features and functionality of various components can be combined into single components as appropriate.

In some implementations, the API provider systems 106 can expose multiple relevant APIs in advance, with each of the APIs having a different language and a different communication protocol. The user device 104 can include various API consumption tools, for example, API management tools, visual studio (VS) and OS (operating system) software development kits (SDKs), build tools, and web integrated development environment (WebIDE) tools. The communication between the user device 104 (as API consumers) and the API provider systems 106 can include several different communication protocols configured to optimize document data extraction and data search, as further described in detail with reference to FIGS. 2-6.

As described in further detail herein, a user device 104 can send a query through the client application 126 to process a document. In accordance with the implementations of the present disclosure, in response to the request, the document can be digitalized, and relevant contextual data can be retrieved for the document. For example, based on the received query, the client application 126 can be configured to request the processing of the document to the document data extraction system 110 and can provide the document (e.g., by directly sending it or through a reference to storage). In some instances, the requested document for processing can be a document of the documents 120A at the server system 102, where there is available contextual data for the document as part of the contextual data 120B. The contextual data can be retrieved from the storage 114A of the server system. In some instances, if such contextual data is not available at the contextual data 120B, such contextual data can be received from another system associated with the generation of the document or with the storage of the document. For example, a document can be processed to extract data and feed the extracted data into a given system (e.g., an enterprise resource planning (ERP) system).

In some implementations, an enterprise system (such as an ERP system) can be communicatively coupled to one or more components of the document data extraction system 110, including the data cache 118D and the prediction engine 118C. In some instances, the enterprise system can be the API provider system 106 and can include a database (e.g., storage 114C) that can store objects. In some instances, the enterprise system can be the server system 102 and can obtain data to be stored in objects from obtained documents that are processed through the document data extraction system 110. In some instances, stored objects at the enterprise system can be used in numerous processes implemented at the enterprise system or can be provided for use or storage at the server system 102 or another system.

In some instances, the contextual data 120B stored at the server system 102 can be received from an enterprise system (e.g., the ERP system) and can include data defining allowed data ranges, allowed values, allowed data types, and/or reference identifiers for various types of data that can be extracted from documents based on logic implemented at the document data extraction system 110. In some implementations, the document data extraction system 110 can be configured for extracting data and providing it to a given system, and in some cases, the document data extraction system 110 can retrieve contextual data relevant for the given system from the contextual data 120B and temporarily store the context at the data cache 118D of the document data extraction system 110 to utilize the data cache 118D for faster data retrieval for processing documents for feeding data into the given enterprise system.

In some instances, the stored contextual data 120B can be used to be provided to the prompt generation engine 118B to enable prompt generation and enrichment for use as context when extracting data of various types from provided documents. The prompt generation engine 118B can provide the generated and enriched prompt to the prediction engine 118C. The prediction engine 118C can provide machine learning functionality for data extraction from documents, such as the documents 120A, based on prompt generation that can consider contextual data relevant for the documents to support more accurate data extraction that utilizes more efficiently the computational resources of the server system 102. For example, the prediction engine 118C can include large language models (LLMs) or can be used to query external machine learning models based on prompts that can be enriched with contextual information retrieved from the contextual data 120B. For example, when data is extracted from a document by the document data extraction system 110, and the data is to be fed into an enterprise system, the contextual data related to the type of data stored in the enterprise system can be retrieved and used to enrich a prompt to query the machine learning model to extract data from the document.

In some instances, the document data extraction system 110 can include a trained prediction engine(s) 118C that can extract data from documents such as the documents 120A based on prompting with enriched prompts that provide relevant contextual data for the particular document. In some instances, the prediction engine 118C can be a component that generates prompts to be provided as input or query to another machine learning model (that can run on the server system 102, the API provider system 106, or be external to those, among other examples) to obtain extracted data from documents identified with the input or query. In some instances, the contextual data can be provided to the prediction engine 118C (e.g., running an LLM or querying an LLM) to generate a prompt to extract data, where the prompt is enriched with contextual data retrieved based on the context of the request, the type of the document, a type of fields in the document, or other.

In some implementations, the document data extraction results or the data processing results provided based on the logic implemented at the document data extraction system 110 can be provided for display at the GUI 124A of the user device 104, can be displayed at the server system 102, or at another system or device. In some instances, the data extraction results can be sent for storing at an enterprise system or another storage (or storage service), for example, identified in the request for the data extraction. In some examples, the graphical representation can be provided as a web-based rendering using a web rendering runtime that is built into a container (e.g., iframe). In some examples, the graphical representation is compatible with a GUI framework of the container. An example GUI framework includes, without limitation, SAPUI5 provided by SAP SE of Walldorf, Germany.

FIG. 2 is a block diagram of an example system architecture 200 for data extraction, according to some implementations of the present disclosure. The example system architecture 200 includes a new document(s) 202 (e.g., a document provided to the server system 102 of FIG. 1 for processing at the document data extraction system 110, a document of the documents 120A described with reference to FIG. 1), a digitalizing engine 204 (e.g., digitalizing engine 118A described with reference to FIG. 1), a prompt generation engine 206 (e.g., prompt generation engine 118B described in relation to FIG. 1), an enterprise system 208 (e.g., API provider system 106 described with reference to FIG. 1), a data cache 210 (e.g., data cache 118D described with reference to FIG. 1), a prediction engine 212 (e.g., prediction engine 118C described with regard to FIG. 1), and new structured documents 214 (e.g., documents 120A described with reference to FIG. 1). The prompt generation engine 206 includes an input generation engine 216 and an enrichment engine 218. The enterprise system 208 includes a database 220. The database 220 can store data records and configuration data for process execution at the enterprise system 208.

The new document 202 can include a particular layout, which may not be assigned and/or directly detectable. The new document 202 can include data in a format that is not directly searchable by text-based search engines. For example, the new document 202 can include images or scanned documents (e.g., pdf, png, jpeg, tiff), with at least a portion of the document including text in unsearchable format.

The digitalizing engine 204 can be configured to process the new document 202 to generate a digitalized document including data representations in a semantically searchable format. The new document 202 can be processed by an optical character recognition (OCR) application or service to yield the text on the document with spatial information. The digitalizing engine 204 can process the new document 202 to remove noise, to correct skew, to enhance contrast, and to apply text recognition to match identified shapes within the new document 202 to corresponding characters and image identifiers (logos).

In some implementations, after digitalizing the new document 202 through the digitalizing engine 204, the new document 202 can be transformed into a text representation that includes text and spatial information. In some instances, the text and spatial information can be used to derive a layout-preserving representation that captures the two-dimensional layout information of the new document 202 with whitespaces and newlines. In response to determining the relevant document type for the new document 202, components of the prompt generation engine 206 can be invoked to collect information to be used for enriching a prompt that can be used for querying a machine learning model (e.g., an LLM). The prompt generation engine 206 can include multiple components (e.g., the input generation engine 216 and the enrichment engine 218) that work together to generate requests to obtain data from different fields of the document with consideration for contextual information for the given fields and allow the data for those fields as obtained from contextual information stored at the data cache 210. The contextual information that is used for the enhancement of the prompt can be data obtained from the enterprise system 208. In some instances, the data cache 210 can be preconfigured to store such contextual data as a preparation step for supporting the data extraction and the generation of enriched prompts at the prompt generation engine 206.

In some instances, the input generation engine 216 can create an initial structure of the prompt. The input generation engine 216 can process the digitalized document and the document processing request to generate an initial prompt for querying a machine learning model (e.g., as executing at the prediction engine 212 or by invoking the model from the prediction engine 212). The initial prompt can be generated based on transforming the document processing request into a structured format. The enrichment engine 218 can process the structured prompt, received from the input generation engine 216, and can enhance the initial structured prompt with contextual data to improve the quality of the prompt by adding data that when used by the machine learning model to extract data from the digitalized document can yield an efficient yet precise data invocation. In some instances, the prompt enrichment can include adding context, clarifying ambiguities, and/or incorporating relevant portions of external contextual data received from the data cache 210 (retrieved from the enterprise system 208) into the prompt to generate an enriched prompt.

In some instances, when contextual data is retrieved from the data cache 210, the contextual data can be obtained based on identifying contextual data that is relevant for the new document 202 (e.g., as identified with the initial request), or in some cases, can depend on identified specifics of the new document 202. For example, one or more characteristics of the new document 202 can be identified, e.g., at the prompt generation engine 206, which can be used to query the data cache 210 to obtain contextual data that is relevant to the specific document. For example, an identification of the provider or receiver associated with the document can be determined based on particular characteristics of the document. For example, characteristics of the document can be identified based on processing the digitalized document and referencing external data sources to map an identified logo within the digitalized document to a particular provider (e.g., an entity that can be associated with the enterprise system 208) and use the information for the provider to request contextual data from the data cache 118D that is associated with that particular provider. In some instances, based on processing the document, an identification of the type of the document can be performed, which can be used to request to retrieve contextual data for the particular type from the data cache 118D. The data cache 210 can be populated with contextual data during provisioning of the system 200, whereas the data cache 210 can store contextual data from multiple other systems (not shown) other than the enterprise system 208. In some instances, the data cache 210 can be regularly updated when the systems that provide contextual data to the cache experience changes and store different or more data types. In some instances, the data storage, such as the storage 114A can be maintained with up-to-date contextual data from various external systems, where at the inference phase, only contextual data is relevant for particular requests, e.g., requests associated with populating data into the enterprise system 208 can be persisted in the data cache 210 to support fast generation of enriched prompts that can result in fast and accurate data invocation.

The prediction engine 212 can be configured to use the enriched prompt to generate a new structured document 214. In some instances, the prediction engine 212 can include LLMs trained on vast quantities of example documents including unlabeled data to extract data from documents such as the new document 202. In some instances, the prediction engine 212 is configured to receive the enriched prompt from the prompt generation engine 206 and to use the enriched prompt to query a language model and to extract data from the digitalized document based on the enriched prompt. In some instances, the prediction engine 212 can obtain the extracted data and can provide the extracted data to generate a new structured document 214 that can be stored as a record in a designated system, for example, the enterprise system 208 in the cases where the enrichment of the prompt was performed with reference to contextual data relevant for that system.

The LLMs that can run at the prediction engine 212 can include a form of Generative Artificial Intelligence (Gen AI) that has the ability to process text and additional input data (e.g., contextual data). The LLMs can include, for example, GPT-3.5 Turbo, GPT-4, or GPT-4o, among other examples. The LLMs can be utilized in the creation of structured documents 214, being configured to learn intricate design patterns and to possess semantic understanding for tasks related to natural language processing. The prediction engine 212 (e.g., LLM) can be stateless such that no data or sessions are stored unless a storage in the memory feature is enabled. For example, digitalized documents received from the digitalizing engine 204, can be retrieved and processed as transient objects to generate structured documents 214. The document data processing requests require contextual data, which can be identified based on document and/or entity identifiers received with the document data processing requests.

In some instances, the prompt generation engine 206 can condition the prediction engine 212 to use a prompt enriched with the external information (e.g., contextual information as obtained from the data cache, from a storage, or directly from a reference system) and can help the prediction engine 212 to disambiguate candidates for extraction to ultimately reduce the rate of the errors in the extracted data. For example, if the number range for the customer material number is set to be 4900-5000 and the material number on the delivery note is not in the indicated range, the prediction engine 212 can conclude that the number on the document can be the associated to a supplier material number. As another example, if the list of possible payment terms is given and no payment terms are specified on an invoice, the prediction engine 212 is less prone to hallucinate any of the payment terms and can instead correctly return an empty prediction to be provided with the valid options for payment terms.

The example system architecture 200 provides an efficient prompt generation engine 206 for reducing the search space to set intervals defined by contextual data and to increase data extraction accuracy when extraction is performed through the prediction engine 212 based on contextually enriched prompts.

FIG. 3 is an example prompt 300 generation scenario for data extraction, according to some implementations of the present disclosure. The example prompt 300 can include multiple sections according to a schema definition for the prompt. Different schema definitions can be available for different document types. As such, the prompt structure can be generated according to the determined type of the document that is to be processed.

A first section 302 of the example prompt 300 includes static information derived from a schema definition for the prompt. The first section 302 of the example prompt 300 includes syntaxes identifying formatting instructions and an output schema.

A second section 304 of the example prompt 300 includes a portion enriched with contextual data received from the Enterprise system. The second section 304 of the example prompt 300 includes an identification of contextual data (additional information) and one or more limits/ranges applied to the data to be extracted by the prediction engine.

A third section 306 of the example prompt 300 includes a digitalized (e.g., OCR-ed) version of the document. The third section 306 of the example prompt 300 can include the detected text structure (by inserting whitespaces and newlines) according to an original layout of the document. The example prompt 300 can be compiled using the pre-defined schema for the document type, information extracted from different components to enrich queries related to different fields of the document, and the layout-preserving text representation. The example prompt 300 can be sent to a language model (e.g., the prediction engine 212 of FIG. 2) to extract data from one or more data fields from the digitalized documents.

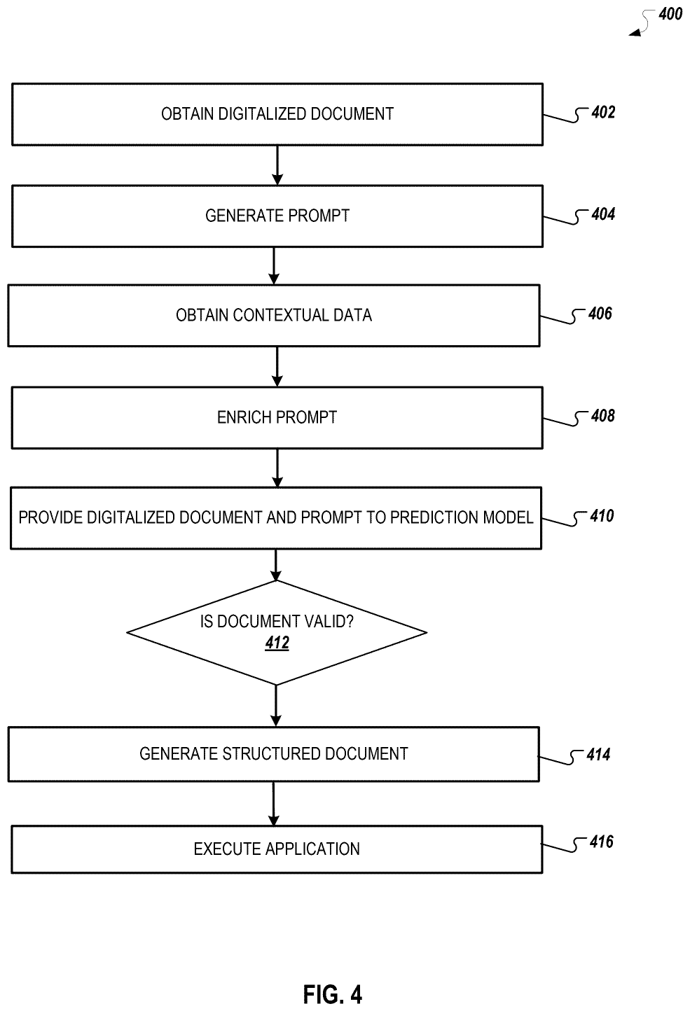

FIG. 4 is a flowchart of an example process 400 for data extraction based on layout identification, according to some implementations of the present disclosure. The example process 400 can be performed by any component of the example system 100, described with reference to FIG. 1, or the example document data extraction system architecture 200, described with reference to FIG. 2, or the example process 400, described with reference to FIG. 4. For clarity of presentation, the description that follows generally describes example process 400 in the context of FIGS. 1, 2, 3, and 4.

At 402, a digitalized document is obtained, by one or more processors (e.g., any component of document data extraction system 110 described with reference to FIG. 1, the document data extraction system architecture 200 described with reference to FIG. 2). Obtaining the digitalized document can include receiving, from a sender (e.g., user device 104 described with reference to FIG. 1) a new document (original document) and digitalizing the new document. The new document (e.g., document 202 described with reference to FIG. 2) includes a document that can be associated with auxiliary data (e.g., metadata and/or address indicative of a party, such as a sender and/or receiver). In some instances, the new document can be received in a format that is not directly searchable by text-based search engines being formatted as an image or a scanned document (e.g., pdf, png, jpeg, tiff). Digitalizing the new document can be executed by a digitalizing engine (e.g., the digitalizing engine 118A, 204 described with regards to FIGS. 1 and 2, respectively, or another OCR solution). Digitalizing the new document includes processing the new document to generate the digitalized document to include data representations in a semantically searchable format. In some implementations, the new document includes a set of new documents, and digitalizing the set of new documents includes the generation of a text representation of each page of the documents in the set of documents. The generation of the text representation can include a generation of an approximation of the original layout of the text elements using whitespaces between grouped portions of the document (e.g., header, sender data, document identifying data, receiver data, and itemized data). For example, the digitalized document contains both the text and the spatial information and can be used to derive a layout-preserving text representation capturing the two-dimensional layout information with whitespaces and section dividers (e.g., newlines).

At 404, a prompt is generated, by the one or more processors. The prompt includes formatting instructions and a data field extraction schema corresponding to a document type determined for the digitalized document. In some instances, to generate the prompt, a document type of the digitalized document can be determined based on the structural characteristics of the digitalized document that define the respective layout of the digitalized document. In some instances, based on identifying an image in the digitalized document and mapping it to a particular system or entity, a determination of the type of the document can be made (e.g., when the entity is a provider that issues only invoices for provided services). In some cases, the identification of the type of document can be made based on identifying the layout of the document (or at least identifying a relatively similarly organized document).

In some instances, when the prompt is generated, the data field extraction schema is obtained for the document type. The data field extraction schema can include identified fields (e.g., price, quantity, date, etc.) and value types corresponding to the listed fields (e.g., string, integer, double, time, date, datetime, etc.). In some instances, the value types can include reference numbers of set formats that can be used to uniquely identify entities in the document (e.g., and specific to a given system, such as the enterprise system 208 as described in relation to FIG. 2.).

At 406, contextual data is obtained from a storage, by the one or more processors, based on invoking multiple submodules related to different portions of the corresponding document type. The contextual data includes range restrictions applicable to the values of digitized document. Examples of range restriction types include reference identifiers (e.g., matter number, document numbers per document type, sender reference numbers in correspondence to receiver reference numbers defined by the receiver of the document and are known to be from a particular number range (e.g., all document numbers of a particular document type can be between 51000000 and 51999999)). Contextual data can be specific per the data field part of the document. For example, even if two data fields are for numerical values, the acceptable values for the two fields may be different based on the defined data schema for the document. For example, a social security number and an identifier may be both numerical fields, however, those two fields can have different formats that are expected for such data that can be unique per system or to the nature of the data (e.g., social security numbers may have identical format in one country but can differ between countries). Other contextual data can include ranges of cases where the allowed values are particular by a finite set of values (including an ‘empty’ value for some of them). Other context data can include particular time ranges, deadlines, processing terms (“due in 30 days”, “due in 55 days”, “due in 60 days”), or other time points defined based on a framework agreement between the receiver and the sender. Other contextual data can include units of measure (EA, DAY, HUR, etc.) as defined in the material master data of a supplier. Other context information includes third-party requirements, such as tax types (VAT, reduced VAT, GST, HST, etc.) as available in a particular local market. Other contextual information can include addresses, such as sender and receiver addresses stored in the data processing system (e.g., main company address, addresses of subsidiaries, logistics locations). The addresses can be seen as a restriction on the range of valid billing/shipping/buyer/vendor address fields depending on the document type. The address definition can include both addresses of the receiver as well as addresses of the sender. The contextual data can include data for a document identifier field that includes a document identifier range (e.g., a document number formatted according to a rule). When the contextual data is used for the document identifier field, the contextual data can be used to be compared to a document identifier in a document to determine the validity of the digitalized document.

In some instances, contextual data can be obtained from a data storage such as the data cache 210 described with reference to FIG. 2, a data storage, an external storage, or an application/system. In some instances, the storage can be populated with contextual data during a provisioning phase and used at inference phase by the prompt generation engine to query a model or a prediction engine to extract data from a digitalized document.

For example, during the provisioning of a new tenant for an enterprise system, at a document data extraction system, a connection to the enterprise system can be established and contextual data can be retrieved and stored for use when querying documents relevant for data extraction and storage in the enterprise system. In some implementations, the contextual data can be retrieved data via standardized interfaces from solutions provided by other vendors (e.g., using integration scenarios).

In some instances, the schema definition for the desired document type determines the set of contextual data (such as number ranges) that is to be retrieved. The contextual data for a particular party (tenant) can be retrieved and persisted in a storage (e.g., caching database) to minimize latency during execution. In some instances, the contextual data can be obtained during the runtime of the data extraction, e.g., directly from the relevant enterprise system. In regular intervals or upon external triggers, the contextual data in the cache is invalidated and fetched again to ensure that the temporary stored contextual data is up-to-date. In some instances, the contextual data retrieval can be broken down into smaller submodules that are executed in a sequence to efficiently retrieve the contextual data according to a sequence that can be defined by the output schema. Each submodule can perform a specific task that can include accessing information in the enterprise system (e.g., by invoking the relevant interface), storing the information in a storage (e.g., in a cache) (persistence logic), and embedding retrieved contextual information into a prompt generated for querying an LLM (inference logic).

At 408, the prompt is enriched, by the one or more processors, to generate an enriched prompt (e.g., example prompt 300 described with reference to FIG. 3). For the enrichment, each submodule that is relevant for the corresponding document type can be called in a sequence to collect the contextual information for the prompt. The submodules are identified based on the document type. In some instances, the submodules that are used to retrieve contextual data are related to a list of requested fields (e.g., user devices can also choose a subset of fields of interest) for data extraction and the type of the document or the relevant system that is to be used to store the data after extraction. Upon receiving a request for data extraction, each submodule can determine whether to contribute a “hint” to the prompt (in other words, to enrich it for a particular portion of the document as requested) or not, and how to produce the hint using an individual inference logic.

If the field is covered by a submodule is not requested or if the enterprise system does not provide the required information for enrichment (e.g., reference IDs are random and not within a number range), there is no contribution to the enrichment process. For example, a submodule for a field “purchaseOrderNo” can read information from a respective section of a data cache including a number range for the respective tenant (e.g., 41000-41999). The number range can be used to build a hint (associated rule) “a valid number is in the range 41000-41999, e.g., a valid purchase order number starts with 41” to be added to the prompt to enrich the prompt. The identification of a common prefix of the number range can be a part of the module's inference logic and can return the identification of the common prefix to the prompt generation and enrichment logic. As another example, the submodule for the field “paymentTerms” can include the party information to read the terms of payment as maintained in the customer's accounts payable solution and creates the hint “‘due within 30 days’, ‘due within 60 days’or ‘no value’” (e.g., the “no value” option reduces the risk of hallucination) and returns the rule to the prompt generation and enrichment logic.

At 410, the enriched prompt is provided, by the one or more processors, with the digitalized document to a prediction engine. The prediction engine can be configured to process the digitalized document and the enriched prompt to generate a new structured document (e.g., structured document 214 described with reference to FIG. 2). The prediction engine can include LLMs trained on vast quantities of example documents including unlabeled data.

At 412, it can be determined (optionally), by the one or more processors, whether the document is valid. For example, the contextual data can include a document identifier range that is compared to a document identifier (e.g., document name, document title, or document header) to determine the validity of the digitalized document. For example, if a rule defines that the document identifier is set to be within a particular range, which is exceeded by the document identifier, it is determined that either one or more extracted individual values are invalid or that the document is invalid. Alternatively, if the document identifier is within a particular range defined by a rule, it is determined that either one or more extracted individual values are invalid or that the document is valid. In some implementations, document validation includes the application of a matching rule that compares a document identifier with the document identifier of a paired document (e.g., matching a purchase order identifier with an invoice order identifier).

At 414, in response to determining that the document is valid, a structured document is generated, by the one or more processors, using the digitalized document. Generating the structured document can include data extraction from the digitalized document according to a document layout corresponding to the digitalized document. Data extraction from the digitalized document can include formatting the data for further data processing. In some instances, layout-based data extraction from the digitalized document can include rule-based extraction heuristics, using neural network-based extraction models such as DocumentReader, Charmer, Large Language Models (LLM), or post-processing logic such as sender address harmonization and matching. The layout-based data extraction can be distributed to be executed by multiple data extraction modules according to a message-based orchestration sequence. The results of the different data extraction modules can be merged, verified, and persisted to be retrieved by an embedding solution. In some implementations, verification includes matching values of paired documents, such as a first document generated by a sender (e.g., purchase order) and a second document generated by a collaborating party, such as a receiver (e.g., invoice order).

At 416, a trigger to execute an application process is provided, by the one or more processors. The trigger is generated in response to generating the structured document or in response to receiving a request for processing the structured document. For example, the application executes a search of the semantically searchable format of the structured document and processes data extracted from the structured document. The execution of the application can include invoking one or more APIs of a system or application and providing the extracted data to trigger a process. The execution of the application can include generating an artifact (e.g., a document or a data model) matching one or more APIs provided by an enterprise system. The execution of the application can include code generation for connection to a selected API to generate a data flow and/or trigger a process flow. The output of the automatically executed application and the extracted data based on the executed search can be displayed by a graphical user interface on a display device.

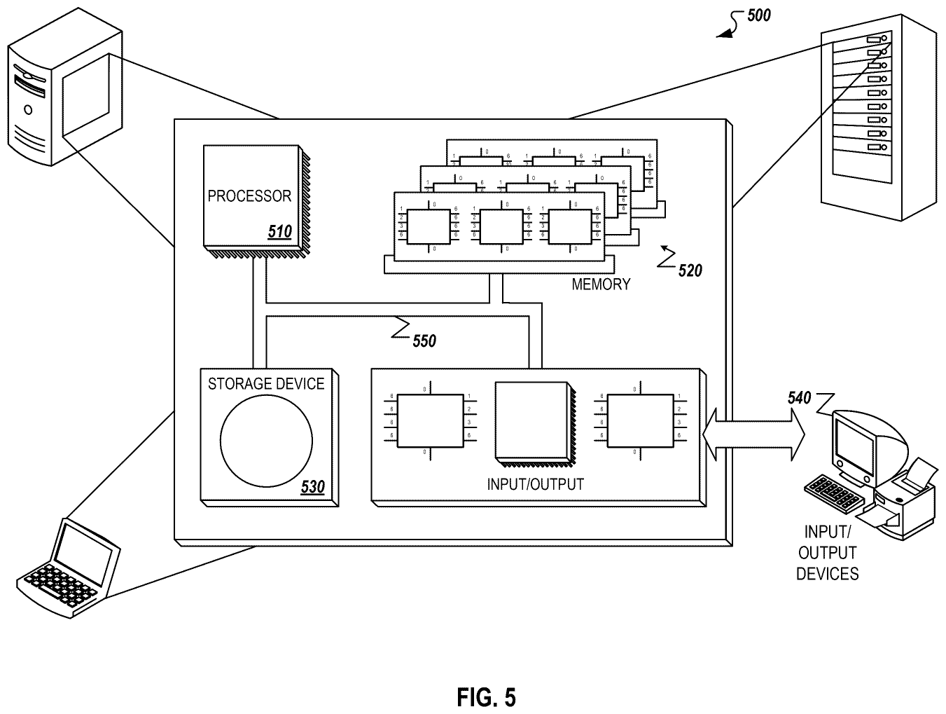

FIG. 5 is a block diagram of an example computing system 500 used to provide computational functionalities associated with described algorithms, methods, functions, processes, flows, and procedures, according to some implementations of the present disclosure. As shown in FIG. 5, the computing system 500 can include a processor 510, a memory 520, a storage device 530, and input/output devices 540. The processor 510, the memory 520, the storage device 530, and the input/output devices 540 can be interconnected using a system bus 550. The processor 510 is capable of processing instructions for execution within the computing system 500, such as the example process 400 described with reference to FIG. 4. Such executed instructions can implement one or more components of, for example, the document data extraction system 110, described with reference to FIG. 1. In some implementations of the current subject matter, the processor 510 can be a single-threaded processor. Alternatively, the processor 510 can be a multi-threaded processor. The processor 510 is capable of processing instructions stored in the memory 520 and/or on the storage device 530 to display graphical information for a user interface provided using the input/output device 540.

The memory 520 is a computer-readable medium such as volatile or non-volatile that stores information within the computing system 500. For example, the memory 520 can store data structures representing configuration object databases. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a LAN, a WAN, or the Internet).

In some implementations of the current subject matter, the computing system 500 can be used to execute various interactive computer software applications that can be used for organization, analysis, and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities (e.g., SAP Integrated Business Planning add-in for Microsoft Excel as part of the SAP Business Suite, as provided by SAP SE, Walldorf, Germany), or can be standalone computing products and/or functionalities. Upon activation within the applications, the functionalities can be used to generate the user interface provided using the input/output device 540. The user interface can be generated and presented to a user by the computing system 500 (e.g., on a computer screen monitor).

One or more aspects or features of the subject matter described herein can be realized in digital electronic circuitry, integrated circuitry, specially designed ASICs, FPGAs computer hardware, firmware, software, and/or combinations thereof. These various aspects or features can include implementation in one or more computer programs that are executable, and/or interpretable on a programmable system including at least one programmable processor, which can be special or general purpose, coupled to receive data and instructions, and to transmit data and instructions to a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus, and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory, a magnetic hard drive, or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices, associated interpretation software, and the like.

The preceding figures and accompanying description illustrate example processes and computer-implementable techniques. The environments and systems described above (or their software or other components) may contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of particular implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter, this application discloses the following list of examples, wherein one feature of an example in isolation or more than one feature of said example taken in combination and, optionally, in combination with one or more features of one or more further examples are further examples also falling within the disclosure of this application.

Example 1: A computer-implemented method comprising:
obtaining a digitalized document comprising data fields in a layout-preserving text representation comprising structural characteristics defining a respective layout;
determining a document type of the digitalized document based on the structural characteristics of the digitalized document;
obtaining, from a storage, contextual data related to the document type of the digitalized document;
generating a prompt comprising a data field extraction schema corresponding to the document type of the digitalized document;
enriching the prompt based on the contextual data and the respective layout of the data fields in the digitalized document to generate an enriched prompt, wherein the enriched prompt defines ranges for one or more data fields;
obtaining, from an execution of a prediction engine, a structured document based on the enriched prompt invoked for the digitalized document; and
providing the structured document for semantic querying to extract portions of data from the structured document to trigger a process execution at an application based on the extracted portions of data.

Example 2. The computer-implemented method of Example 1, wherein obtaining the digitalized document comprises:
receiving, from an external system, an original document comprising a semantically unsearchable format, the external system being identified by sender information; and
applying text recognition and formatting alpha-numeric values according to set formatting rules to the original document.

Example 3. The computer-implemented method of Example 2, wherein the enriched prompt comprises the digitalized document formatted according to an original layout of the original document.

Example 4. The computer-implemented method of Example 2, wherein the ranges for the data fields are determined based on the sender information.

Example 5. The computer-implemented method of any one of the preceding Examples, wherein the contextual data comprises a document identifier range that is compared to a document identifier to determine a validity of the digitalized document.

Example 6. The computer-implemented method of any one of the preceding Examples, wherein values of the data fields are processed using one or more rules defining a validity of the values according to the document type.

Example 7. The computer-implemented method of any one of the preceding Examples, wherein the storage is populated with data during provisioning.

Example 8. The computer-implemented method of any one of the preceding Examples, wherein obtaining, from the storage, the contextual data related to the document type of the digitalized document comprises invoking multiple submodules related to different portions of the corresponding document type.

What is claimed is:

1. A computer-implemented method comprising:
obtaining a digitalized document comprising data fields in a layout-preserving text representation comprising structural characteristics defining a respective layout;
determining a document type of the digitalized document based on the structural characteristics of the digitalized document;
obtaining, from a storage, contextual data related to the document type of the digitalized document;
generating a prompt comprising a data field extraction schema corresponding to the document type of the digitalized document;
enriching the prompt based on the contextual data and the respective layout of the data fields in the digitalized document to generate an enriched prompt, wherein the enriched prompt defines ranges for one or more data fields;
obtaining, from an execution of a prediction engine, a structured document based on the enriched prompt invoked for the digitalized document; and
providing the structured document for semantic querying to extract portions of data from the structured document to trigger a process execution at an application based on the extracted portions of data.

2. The computer-implemented method of claim 1, wherein obtaining the digitalized document comprises:
receiving, from an external system, an original document comprising a semantically unsearchable format, the external system being identified by sender information; and
applying text recognition and formatting alpha-numeric values according to set formatting rules to the original document.

3. The computer-implemented method of claim 2, wherein the enriched prompt comprises the digitalized document formatted according to an original layout of the original document.

4. The computer-implemented method of claim 2, wherein the ranges for the data fields are determined based on the sender information.

5. The computer-implemented method of claim 1, wherein the contextual data comprises a document identifier range that is compared to a document identifier to determine a validity of the digitalized document.

6. The computer-implemented method of claim 1, wherein values of the data fields are processed using one or more rules defining a validity of the values according to the document type.

7. The computer-implemented method of claim 1, wherein the storage is populated with data during provisioning.

8. The computer-implemented method of claim 1, wherein obtaining, from the storage, the contextual data related to the document type of the digitalized document comprises invoking multiple submodules related to different portions of the corresponding document type.

9. A system comprising:
a computing device; and
a computer-readable storage device coupled to the computing device and having instructions stored thereon which, when executed by the computing device, cause the computing device to perform operations for selectively generating graphical representations with digital assistants in enterprise systems, the operations comprising:
obtaining a digitalized document comprising data fields in a layout-preserving text representation comprising structural characteristics defining a respective layout;
determining a document type of the digitalized document based on the structural characteristics of the digitalized document;
obtaining, from a storage, contextual data related to the document type of the digitalized document;
generating a prompt comprising a data field extraction schema corresponding to the document type of the digitalized document;
enriching the prompt based on the contextual data and the respective layout of the data fields in the digitalized document to generate an enriched prompt, wherein the enriched prompt defines ranges for one or more data fields;
obtaining, from an execution of a prediction engine, a structured document based on the enriched prompt invoked for the digitalized document; and
providing the structured document for semantic querying to extract portions of data from the structured document to trigger a process execution at an application based on the extracted portions of data.

10. The system of claim 9, wherein obtaining the digitalized document comprises:
receiving, from an external system, an original document comprising a semantically unsearchable format, the external system being identified by sender information; and
applying text recognition and formatting alpha-numeric values according to set formatting rules to the original document.

11. The system of claim 10, wherein the enriched prompt comprises the digitalized document formatted according to an original layout of the original document.

12. The system of claim 10, wherein the ranges for the data fields are determined based on the sender information.

13. The system of claim 9, wherein the contextual data comprises a document identifier range that is compared to a document identifier to determine a validity of the digitalized document.

14. The system of claim 9, wherein values of the data fields are processed using one or more rules defining a validity of the values according to the document type.

15. The system of claim 9, wherein the storage is populated with data during provisioning.

16. A non-transitory computer-readable media encoded with a computer program, the computer program comprising instructions that when executed by one or more computers cause the one or more computers to perform operations comprising:
obtaining a digitalized document comprising data fields in a layout-preserving text representation comprising structural characteristics defining a respective layout;
determining a document type of the digitalized document based on the structural characteristics of the digitalized document;
obtaining, from a storage, contextual data related to the document type of the digitalized document;
generating a prompt comprising a data field extraction schema corresponding to the document type of the digitalized document;
enriching the prompt based on the contextual data and the respective layout of the data fields in the digitalized document to generate an enriched prompt, wherein the enriched prompt defines ranges for one or more data fields;
obtaining, from an execution of a prediction engine, a structured document based on the enriched prompt invoked for the digitalized document; and
providing the structured document for semantic querying to extract portions of data from the structured document to trigger a process execution at an application based on the extracted portions of data.

17. The non-transitory computer-readable media of claim 16, wherein obtaining the digitalized document comprises:
receiving, from an external system, an original document comprising a semantically unsearchable format, the external system being identified by a sender information; and
applying text recognition and formatting alpha-numeric values according to set formatting rules to the original document.

18. The non-transitory computer-readable media of claim 17, wherein the enriched prompt comprises the digitalized document formatted according to an original layout of the original document.

19. The non-transitory computer-readable media of claim 17, wherein the ranges for the data fields are determined based on the sender information.

20. The non-transitory computer-readable media of claim 16, wherein the contextual data comprises a document identifier range that is compared to a document identifier to determine a validity of the digitalized document.
